(19) United States
(12) Patent Application Publication
(10) Pub. No.: US 2024/0367733 A1
(43) Pub. Date: Nov. 7, 2024

(54) Standing Crawler Self-propelled Apparatus

(71) Applicant: ZHEJIANG KC MECHANICAL & ELECTRICAL CO., LTD., Yongkang City, Zhejiang (CN)

(72) Inventors: Haoyu YING, Yongkang City, Zhejiang (CN); Xiaowei SUN, Yongkang City, Zhejiang (CN); Yisheng LU, Yongkang City, Zhejiang (CN)

(21) Appl. No.: 18/005,018

(22) PCT Filed: Dec. 12, 2022
(86) PCT No.: PCT/CN2022/138343

§ 371 Date: Jan. 10, 2023

(30) Foreign Application Priority Data
Nov. 22, 2022 (CN) 202211468971.X
Nov. 22, 2022 (CN) 202223102517.0
Nov. 22, 2022 (CN) 202223102563.0

(51) Int. Cl. B62D 55/084; B62D 55/06; B62D 55/125; B62D 55/14; B62D 55/24; E01H 5/09

(52) U.S. Cl. CPC B62D 55/084; B62D 55/06; B62D 55/125; B62D 55/14; B62D 55/24; E01H 5/098

(57) ABSTRACT

The disclosure provides a standing crawler self-propelled apparatus, including an apparatus body, a console, and a crawler mechanism. A pedal is flippably installed on a rear end of the apparatus body. Output shafts are symmetrically installed on both sides of the apparatus body. The console is installed on the apparatus body. The console is movably provided with a stroke control rod and a function control rod. A linkage mechanism is installed between the stroke control rod and the function control rod. One end of the crawler mechanism is connected to the output shaft, and the other end of the crawler mechanism is movably hinged to the apparatus body by a height adjusting mechanism. The height adjusting mechanism includes a height adjusting motor and a swing rod group. The linkage mechanism includes a slide rod, a slide rod seat, and a linkage block.

### CROSS REFERENCE TO RELATED APPLICATIONS

This application is a U.S. national phase of International Application No. PCT/CN2022/138343 filed on Dec. 12, 2022, which claims priority to Chinese Application No. 202211468971.X filed Nov. 22, 2022, Chinese Application No. 202223102517.0 filed Nov. 22, 2022, and Chinese Application No. 202223102563.0 filed Nov. 22, 2022, all of which are incorporated by reference herein in their entirety.

### FIELD OF DISCLOSURE

The disclosure relates to the field of standing self-propelled apparatuses, and in particular to a standing crawler self-propelled apparatus.

### BACKGROUND

Snow sweeper is a kind of self-propelled apparatus. The snow sweeper which is an important apparatus for snow removal in winter is mainly composed of a prime motor, a transmission device, a snow collecting device, a snow throwing device, a walking system and an operating system. The snow sweeper crushes and collects ice and snow on the road surface by a snow pushing shovel or a spiral auger. The snow throwing device in the snow sweeper is used to throw the collected snow to one side of the road or to centralize the collected snow.

The applicant applied for a Chinese utility model patent with the application number of “CN202220358576.5” and the title of “Standing Zero Steering Snow Sweeper” on Feb. 22, 2022, which discloses a standing zero steering snow sweeper, particularly including a snow sweeper body, and the snow sweeper body is provided with a snow sweeping mechanism, a control mechanism, a standing mechanism and a driving mechanism. The driving mechanism is connected to a tire assembly of the snow sweeper through a gearbox assembly, and the control mechanism controls the gearbox assembly and the snow sweeping mechanism through a power device connection. The snow sweeper adopts a tire walking mode. Under extremely bad road conditions, the snow sweeper tires slip, and the snow sweeping mechanism of the snow sweeper does not have a height adjustable function. In addition, the applicant synchronously applied for a Chinese utility model patent with the application number of “CN202220674192.4” and the title of “Structure of Operating Panel of Standing Snow Sweeper” for the control mechanism of the utility model. Particularly, it includes a panel shell and a control rod assembly, and the control rod assembly is provided on both sides of the upper end of the panel shell to control the wheel rotation of the snow sweeper. The control rod assembly includes a left control rod and a right control rod, the left control rod is connected to and controls the left tire of the snow sweeper, and the right control rod is connected to and controls the right tire of the snow sweeper, and the left control rod of the control rod assembly can only control the travel of the snow sweeper, and cannot control the rotation of the snow sweeping auger in a linkage manner.

### SUMMARY

### (I) Technical Problems to be Solved

The disclosure aims to provide a standing crawler self-propelled apparatus to overcome the defects in the prior art.

### (II) Technical Solution

To solve the technical problem, the disclosure provides a standing crawler self-propelled apparatus, which is applicable to snow sweeper apparatuses, particularly including an apparatus body, a console and a crawler mechanism, a pedal is flippably installed on a rear end of the apparatus body, an operator stands on the pedal when the machine works; output shafts are symmetrically installed on both sides of the apparatus body; the console is installed on the apparatus body, the console is movably provided with a stroke control rod and a function control rod, and a linkage mechanism is installed between the stroke control rod and the function control rod; one end of the crawler mechanism is connected to the output shafts, and the other end of the crawler mechanism is movably hinged to the apparatus body by a height adjusting mechanism. The stroke control rod is used to control the travel of the snow sweeper, and the function control rod is used to control the rotation of a snow sweeping auger at the front end of the snow sweeper.

Further, the height adjusting mechanism may be used to adjust the relative angular position of the apparatus body and the crawler mechanism, and particularly includes a height adjusting motor and a swing rod group hinged into the apparatus body, a motor base of the height adjusting motor is hinged into the apparatus body, and the height adjusting motor is connected to a push rod by a screw rod mechanism; the swing rod group includes a first swing rod and a second swing rod mutually fixed; the first swing rod is hinged to the push rod, and the second swing rod is hinged to the crawler mechanism; the first swing rod and the second swing rod are welded and fixed by a hinged shaft, a stroke limit switch is installed on the height adjusting motor to define an upper limit position and a lower limit position of the push rod, and a tension spring is connected between the swing rod group and the apparatus body.

Further, the linkage mechanism includes a slide rod, a slide rod seat and a linkage block, the slide rod is slidably installed on the slide rod seat, one side of the slide rod is in contact with the stroke control rod, the linkage block is hinged to a hinged support frame in the console, and the linkage block is provided with a linkage clamp slot able to clamp the function control rod; during combined operation of the stroke control rod and the function control rod, the function control rod is manually pushed into the linkage clamp slot; the slide rod seat is installed on the hinged support frame, and a reset spring is installed between the linkage block and the hinged support frame; the operator can control the two control rods to operate in a linkage manner, or control the two control rods to reset, as long as an external force applied to the stroke control rod is released; the reset of the linkage block makes the function control rod disengage from the linkage clamp slot, and the reset of the function control rod makes the snow sweeping auger at the front end of the snow sweeper stop working; and the function control rod may also be manually and separately pushed to disengage from the linkage clamp slot for reset.

Further, a slide shaft is formed at one end of the slide rod, and the slide shaft is matched with a first kidney slot of the linkage block; the hinged support frame is provided with a gear slot for accommodating the function control rod, in a linkage operation state, a “7”-shaped slot is formed between the linkage block and the gear slot, and the function control rod is guided to be clamped in the linkage clamp slot by the “7”-shaped slot.

Further, a lower end of the function control rod is provided with a drive plate, one side of the drive plate is slidably sleeved over a support frame sheet, and the support frame sheet is fixed on a first gear rotation shaft in the console; the drive plate is slidably sleeved over the first gear rotation shaft, and a compression spring is installed between the drive plate and a shaft end of the first gear rotation shaft; when the combined operation needs to be manually released, the function drive rod is pushed in an axial direction of the first gear rotation shaft, the drive plate deflects with an upper end edge of the support frame sheet as a fulcrum, and the function control rod is disengaged from the linkage clamp slot; and the drive plate is sleeved over a guide pin of the support frame sheet, and the drive plate is installed on the first gear rotation shaft by a second kidney slot. The lower end of the stroke drive rod is hinged to the gear seat, the gear seat is fixed on a second gear rotation shaft in the console, the gear seat is provided with a safety switch with a spring, and the stroke drive rod is always in a depressed state to be in contact with the safety switch during operation.

Further, the crawler mechanism includes a crawler, a transmission gear and a support frame, the output shaft is connected to the transmission gear by a bearing seat, and the transmission gear is matched with a through slot of the crawler; and a plurality of pairs of guide teeth are uniformly installed on the inner side of the crawler, and a guide cavity corresponding to the transmission gear is formed between each pair of guide teeth. By applying the crawler mechanism to the snow sweeper, the use range of the snow sweeper is improved.

Further, bearing wheels are installed on both sides of a lower end of the support frame, the lower end of the support frame is movably hinged to a V-shaped frame and a floating guide wheel installed on the V-shaped frame, the bearing wheels and the floating guide wheel are arranged outside the guide teeth, which can play a role in guiding the crawler, the support frame is provided with a tensioning wheel that can adjust the tightness of the crawler, and the tensioning wheel correspondingly falls into the guide cavity, which can also play a role in guiding the crawler.

Further, a snow outlet cover is rotatably installed on a snow sweeping cover shell at a front end of the apparatus body, a gear ring is installed at a lower end of the snow outlet cover, and a steering motor and a steering gear engaged with the gear ring are installed on the snow sweeping cover shell.

Further, the apparatus body is provided with a pedal fixing sheet, a locking sheet is hinged to the pedal fixing sheet, the pedal fixing sheet is provided with a locking slot, and a locking pin of the pedal is rotated and clamped into the locking slot by the locking sheet.

### (III) Beneficial Effect

Compared with the prior art, the standing crawler self-propelled apparatus provided by the disclosure has the following advantages: 1) The apparatus travels through the crawler mechanism, does not easily slip, has good obstacle surmounting performance, and can adapt to extreme road conditions. 2) The crawler mechanism is connected to the apparatus body by the height adjusting mechanism, which can adjust the angle position of the apparatus body relative to the crawler mechanism (applied to the snow sweeper apparatus, the height position between the front snow sweeping auger and the crawler mechanism can be adjusted, and the snow sweeping auger can be lifted during daily standby travel to avoid accidental collision), which can be realized through manual or electric control of two structures. 3) The stroke control rod and the function control rod can be controlled through the linkage mechanism in a linkage manner, the stroke control rod is used to control the travel, and the function control rod is used to control the snow sweeping auger to rotate. In the linkage operation state, the function control rod can be controlled in a linkage manner through the stroke control rod and the linkage mechanism, or the linkage operation state with the stroke control rod can also be released by manually toggling the function control rod. The disclosure can be applied not only to snow sweeper products, but also to apparatuses such as sweepers, snow pushers, weeding machines, etc.

### BRIEF DESCRIPTION OF THE FIGURES

FIG. 1 is a perspective view of the disclosure.

FIG. 2 is a perspective view of the disclosure from another perspective.

FIG. 3 is an enlarged view of I in FIG. 2 of the disclosure.

FIG. 4 is an exploded view of a pedal of the disclosure.

FIG. 5 is an exploded view of a crawler mechanism and an apparatus body of the disclosure.

FIG. 6 is a perspective view of the crawler mechanism of the disclosure.

FIG. 7 is a schematic structural diagram of the crawler mechanism of the disclosure.

FIG. 8 is a perspective view of a crawler of the disclosure.

FIG. 9 is a perspective view of a height adjusting mechanism of the disclosure.

FIG. 10 is a perspective view of a height adjusting motor of the disclosure.

FIG. 11 is a perspective view of a swing rod group of the disclosure.

FIG. 12 is a perspective view of a linkage mechanism of the disclosure.

FIG. 13 is a perspective view of a stroke control rod and a function control rod of the disclosure when they are in a linkage operation state.

FIG. 14 is an exploded view of the linkage mechanism of the disclosure.

FIG. 15 is a perspective view of the function control rod of the disclosure.

FIG. 16 is an exploded view of the function control rod of the disclosure.

FIG. 17 is a schematic structural diagram of a linkage block and a hinged support frame of the disclosure.

FIG. 18 is a perspective view of a snow sweeping cover shell and a snow outlet cover of the disclosure.

FIG. 19 is an enlarged view of II in FIG. 18 of the disclosure.

FIG. 20 is a perspective view of an angle adjusting mechanism of the disclosure.

FIG. 21 is a perspective view of two snow sweeping caps of which the snow throwing angles are adjusted to face down.

FIG. 22 is a perspective view of a whole apparatus in embodiment II of the disclosure.

FIG. 23 is a perspective view of a height adjusting mechanism in embodiment II of the disclosure.

FIG. 24 is a perspective view of an upper rotation rod group in embodiment II of the disclosure.

FIG. 25 is a perspective view of a lower rotation rod group in embodiment II of the disclosure.

FIG. 26 is an exploded view of a crawler mechanism in embodiment II of the disclosure.

FIG. 27 is a perspective view of the crawler mechanism in embodiment II of the disclosure.

FIG. 28 is a perspective view of a tensioning wheel group in embodiment II of the disclosure.

The corresponding component names of each reference numeral in the figures are as follows: 1, apparatus body; 2, pedal; 3, output shaft; 4, console; 5, tension spring; 6, stroke control rod; 7, function control rod; 8, linkage mechanism; 9, crawler mechanism; 10, height adjusting mechanism; 11, height adjusting motor; 12, swing rod group; 13, motor base; 14, push rod; 15, first swing rod; 16, second swing rod; 17, hinged shaft; 18, stroke limit switch; 19, slide rod; 20, slide rod seat; 21, linkage block; 22, hinged support frame; 23, linkage clamp slot; 24, reset spring; 25, slide shaft; 26, first kidney slot; 27, gear slot; 28, drive plate; 29, support frame sheet; 30, first gear rotation shaft; 31, compression spring; 32, upper end edge; 33, guide pin; 34, second kidney slot; 35, crawler; 36, transmission gear; 37, support frame; 38, bearing seat; 39, through slot; 40, guide tooth; 41, guide cavity; 42, bearing wheel; 43, V-shaped frame; 44, floating guide wheel; 45, tensioning wheel; 46, snow sweeping cover shell; 47, snow outlet cover; 48, gear ring; 49, steering motor; 50, steering gear; 51, pedal fixing sheet; 52, locking sheet; 53, locking slot; 54, locking pin; 55, gear seat; 56, second gear rotation shaft; 57, first snow sweeping cap; 58, second snow sweeping cap; 59, turning connecting rod; 60, snow outlet cap spring; 61, angle adjusting mechanism; 62, adjusting motor; 63, adjusting gear; 64, sector gear; 65, reel; 66, pulling rope; 67, height adjusting handle; 68, upper rotation rod group; 69, lower rotation rod group; 70, height-adjustable connecting rod; 71, crawler; 72, triangular support frame; 73, crawler transmission wheel, 74, bearing wheel group; 75, tensioning wheel group; 76 height adjusting positioning plate; 77, gear slot; 78, upper stroke limit slot; 79, transmission flange; and 80, transmission tooth part.

### DETAILED DESCRIPTION

The detailed description of the disclosure is further described in detail below in combination with the drawings and embodiments. The following embodiments are used to explain the disclosure, but are not used to limit the scope of the disclosure.

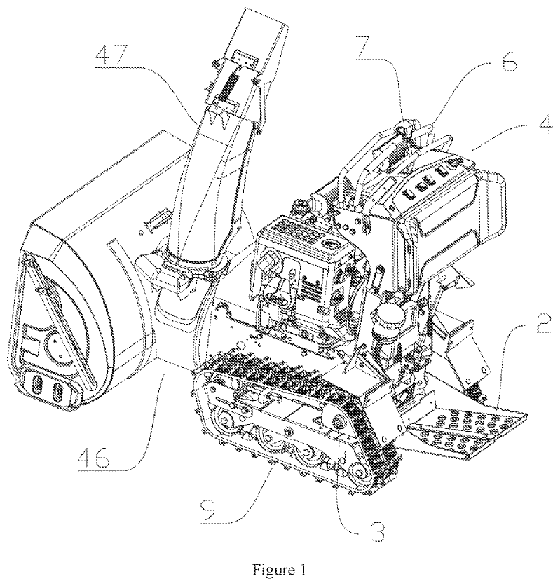

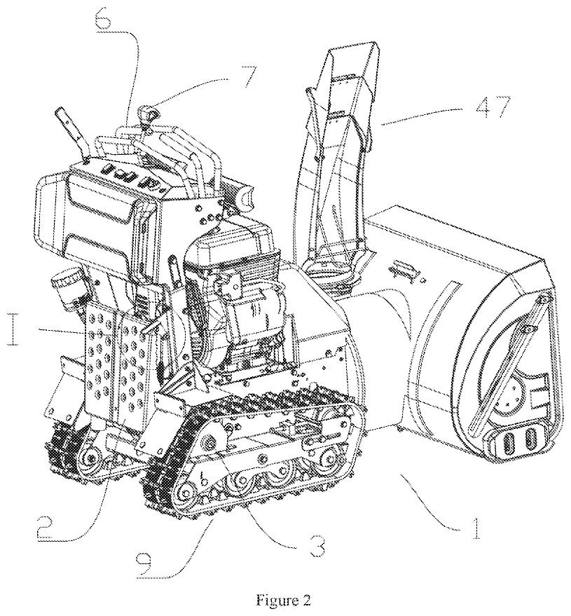

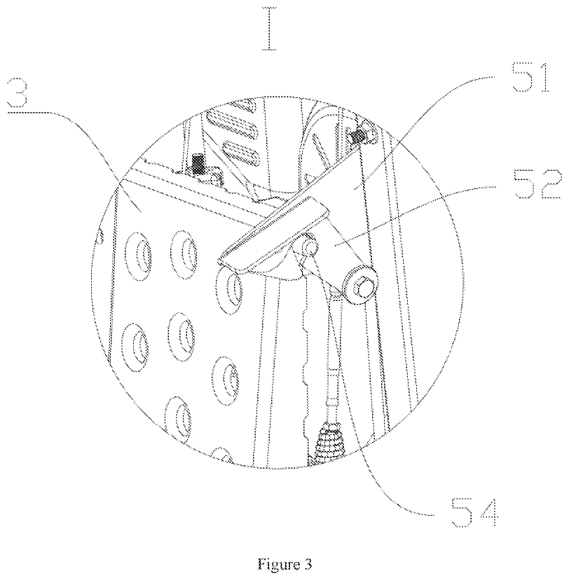

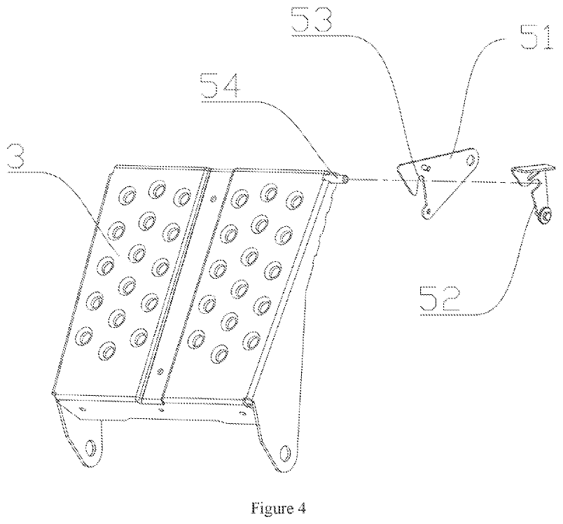

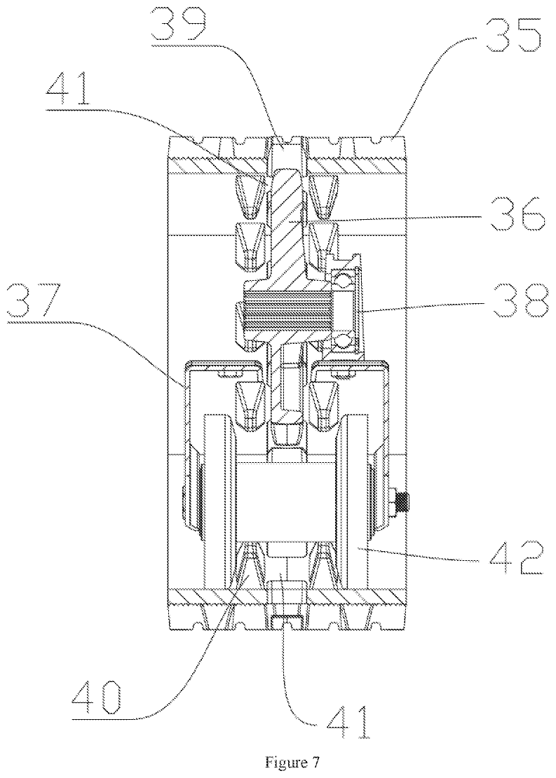

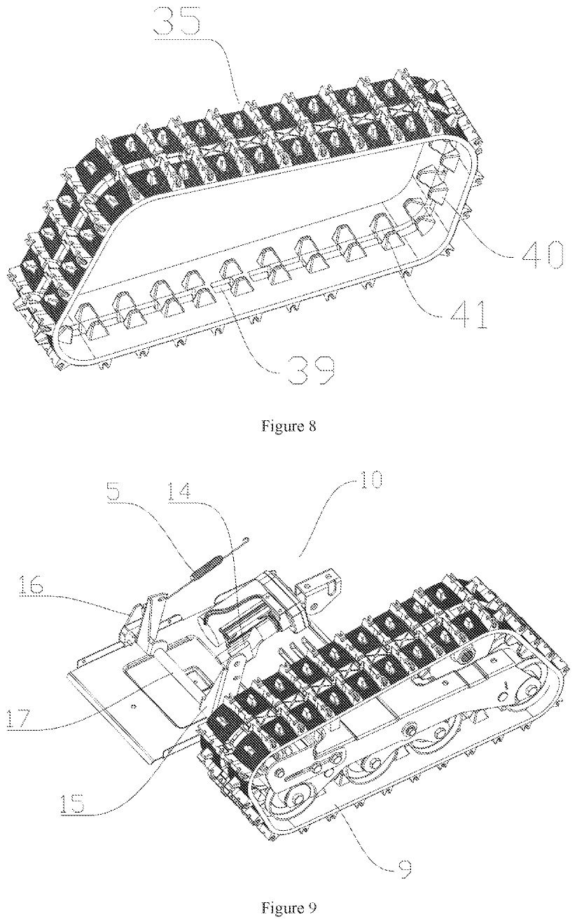

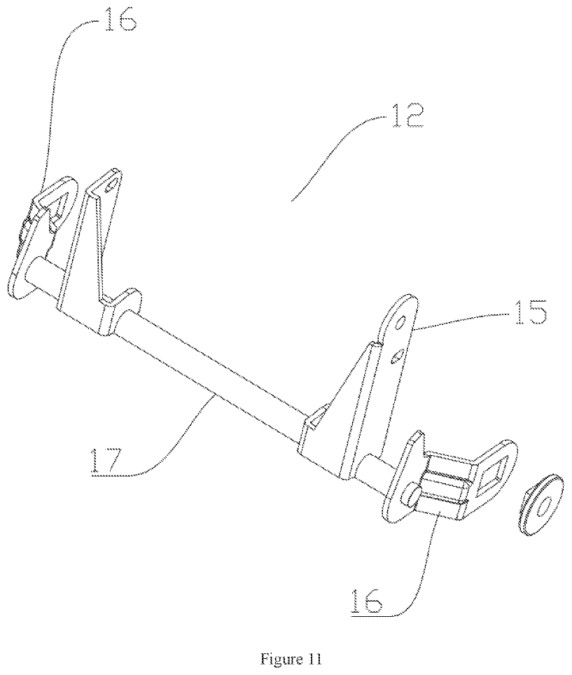

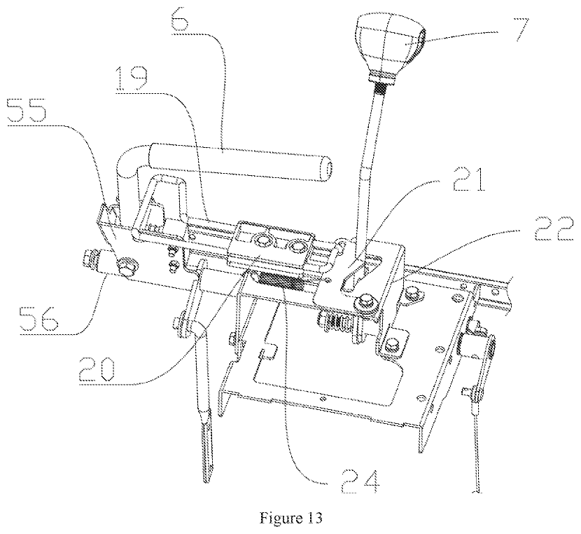

Referring to FIG. 1 to FIG. 21, the disclosure provides a standing crawler self-propelled apparatus, particularly including an apparatus body 1, a console 4 and a crawler mechanism 9. A pedal 2 is flippably installed on the rear end of the apparatus body 1. An operator stands on the pedal 2 when the machine works. Output shafts 3 are symmetrically installed on both sides of the apparatus body 1. The console 4 is installed on the apparatus body 1. The console 4 is movably provided with a stroke control rod 6 and a function control rod 7. A linkage mechanism 8 is installed between the stroke control rod 6 and the function control rod 7. One end of the crawler mechanism 9 is connected to the output shafts 3, and the other end of the crawler mechanism is movably hinged to the apparatus body 1 by a height adjusting mechanism 10. Referring to FIG. 1 and FIG. 2, the self-propelled apparatus in this embodiment is a snow sweeper. The stroke control rod 6 is used to control the travel of the snow sweeper. During operation, the stroke control rod 6 is required to always keep a downward pressure state. The function control rod 7 is used to control the rotation of a snow sweeping auger at the front end of the snow sweeper. Toggling the function control rod 7 forward may control the rotation of the snow sweeping auger.

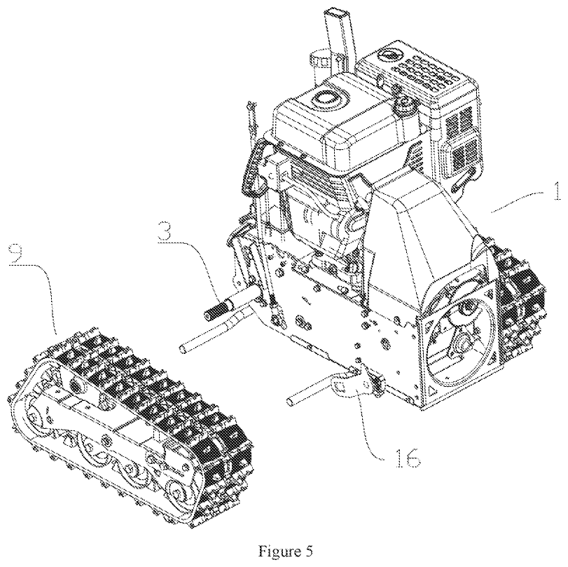

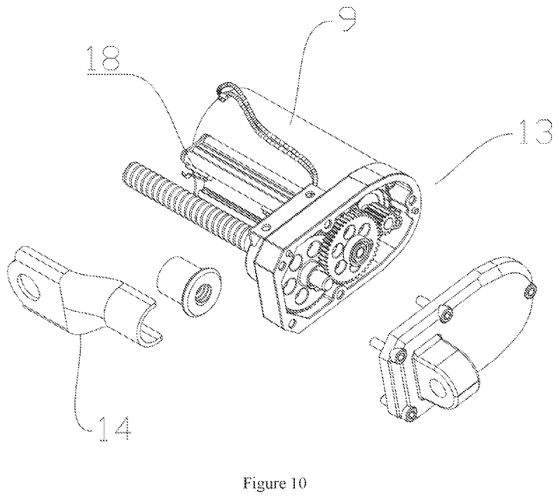

Referring to FIG. 5 and FIG. 9 to FIG. 11, the height adjusting mechanism 10 includes a height adjusting motor 11 and a swing rod group 12 hinged into the apparatus body 1. A motor base 13 of the height adjusting motor 11 is hinged into the apparatus body 1. The motor base 13 is swingingly installed on the corresponding hinged support frame in the apparatus body 1 by a hinged hole. In combination with FIG. 10, the height adjusting motor 11 is connected to a push rod 14 by a screw rod mechanism. A screw rod of the motor base 13 is connected to the height adjusting motor 11 by a gear reduction mechanism. A screw rod seat is installed on the screw rod. The swing rod group 12 includes a first swing rod 15 and a second swing rod 16 mutually fixed. The first swing rod 15 is hinged to the push rod 14. The second swing rod 16 is hinged to the crawler mechanism 9. The first swing rod 15 and the second swing rod 16 are welded and fixed by a hinged shaft 17. A stroke limit switch 18 is installed on the height adjusting motor 11 to correspondingly define an upper limit position and a lower limit position of the push rod 14. That is, the maximum adjustable height and the minimum adjustable height of a snow sweeping cover shell 46 at the front end of the apparatus body 1 are limited. A tension spring 5 is connected between the swing rod group 12 and the apparatus body 1. The screw rod seat of the screw rod mechanism is driven to move by the height adjusting motor 11, so as to drive the push rod 14 to move and correspondingly drive the first swing rod 15 and the second swing rod 16 to swing, so that the relative angle position of the crawler mechanism 9 and the apparatus body 1 changes. The crawler mechanism 9 may swing relative to the apparatus body 1 with the output shaft 3 as a fulcrum, while a crawler 35 of the crawler mechanism 9 is always in contact with the ground, so the apparatus body 1 may move up or down relative to the crawler mechanism through relative motion. The snow sweeping auger is installed in the snow sweeping cover shell 46 at the front end of the apparatus body 1. When the apparatus body 1 swings upward with the output shaft 3 as the fulcrum, the remote snow sweeping auger will be adjusted in height. In FIG. 9 of this embodiment, the push rod 14 at this time is in the upper limit position, and the snow sweeping cover shell 46 and the snow sweeping auger are in the highest position relative to the crawler mechanism 9.

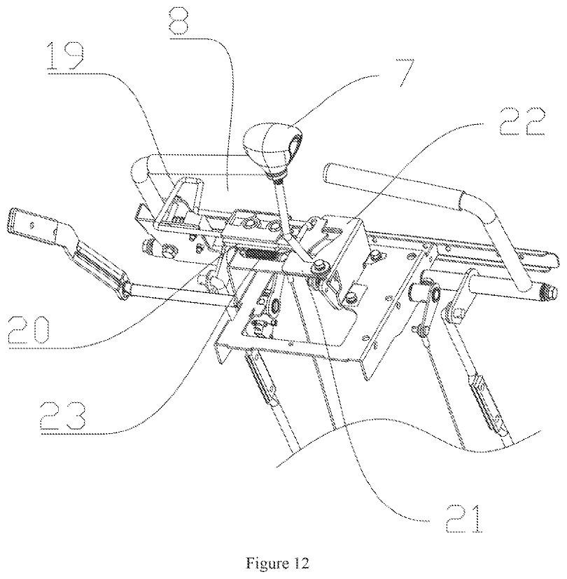

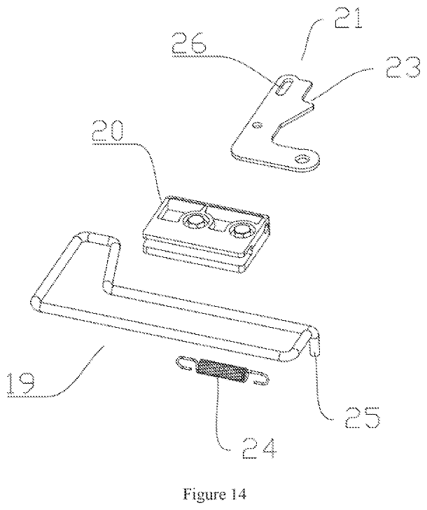

Referring to FIG. 12 to FIG. 14, the linkage mechanism 8 includes a slide rod 19, a slide rod seat 20 and a linkage block 21. The slide rod 19 is slidably installed on the slide rod seat 20. One side of the slide rod 19 is in contact with the stroke control rod 6. The linkage block 21 is hinged to a hinged support frame 22 in the console 4. The linkage block 21 is provided with a linkage clamp slot 23 able to clamp the function control rod 7. During combined operation of the stroke control rod 6 and the function control rod 7, the function control rod 7 is manually pushed into the linkage clamp slot 23. The slide rod seat 20 is installed on the hinged support frame 22. A reset spring 24 is installed between the linkage block 21 and the hinged support frame 22. The operator may control the two control rods to operate in a linkage manner, and may also control the two control rods to reset, as long as an external force applied to the stroke control rod 6 is released. The reset of the linkage block 21 makes the function control rod 7 disengage from the linkage clamp slot 23. The reset of the function control rod 7 makes the snow sweeping auger at the front end of the snow sweeper stop working. The function control rod 7 may also be manually and separately pushed to disengage from the linkage clamp slot 23 for reset. Referring to FIG. 14, the slide rod 19 is in sliding fit with the slide rod seat 20 through the double rod structure, and the guiding effect is good.

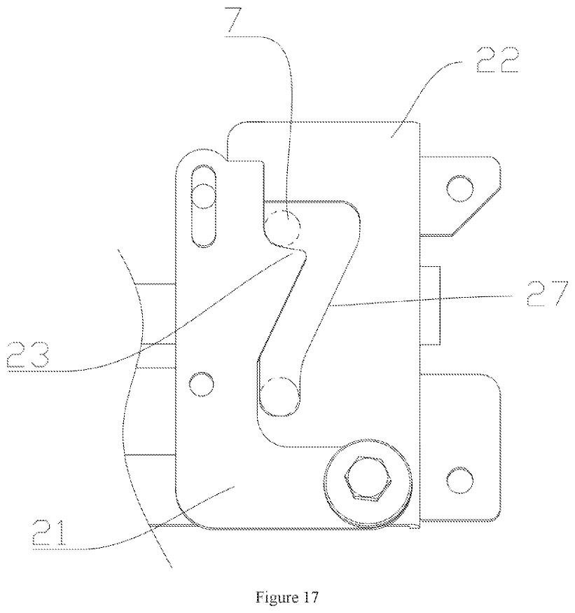

Referring to FIG. 14 to FIG. 17, a slide shaft 25 extending downwards is formed at one end of the slide rod 19. The slide shaft 25 is matched with a first kidney slot 26 of the linkage block 21. The linkage block 21 is driven by the slide shaft 25 to rotate. The hinged support frame 22 is provided with a gear slot 27 for accommodating the function control rod 7. In a linkage operation state, a “7”-shaped slot is formed between the linkage block 21 and the gear slot 27. Referring to FIG. 17 (the two gear positions of the function control rod 7 are shown in the figure, and the function control rod 7 in the figure is represented by the double dot dash line), one side of the linkage block 21 is convex outward to form a guide flange (triangle), and the upper end of the guide flange forms a linkage clamp slot 23. When being manually released from the linkage operation state, the function control rod 7 needs to cross the guide flange to reset.

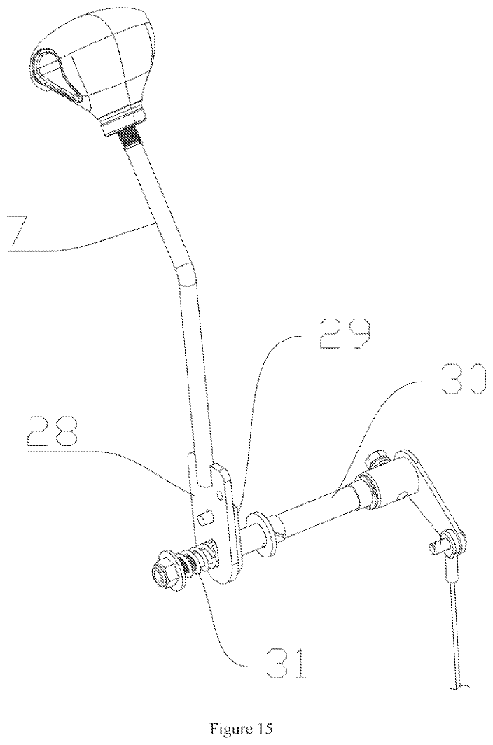

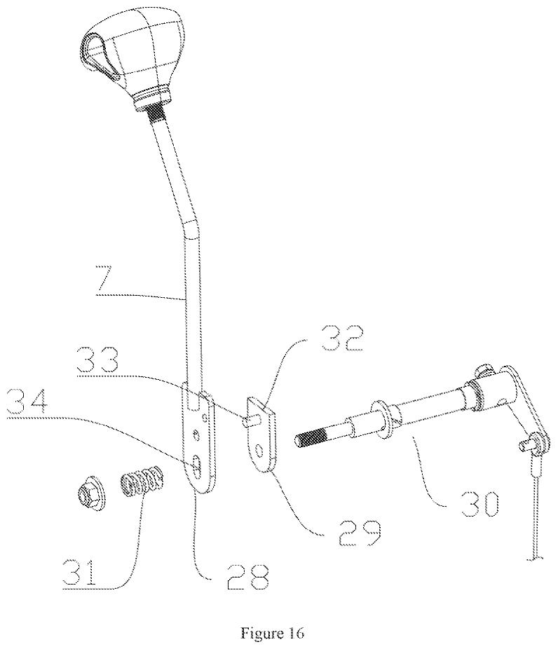

Referring to FIG. 15 to FIG. 16, the lower end of the function control rod 7 is provided with a drive plate 28. One side of the drive plate 28 is slidably sleeved over a support frame sheet 29. The support frame sheet 29 is fixed on a first gear rotation shaft 30 in the console 4. The support frame sheet 29 is perpendicular to the axis of the first gear rotation shaft 30. The drive plate 28 is slidably sleeved over the first gear rotation shaft 30. A compression spring 31 is installed between the drive plate 28 and the shaft end of the first gear rotation shaft 30. The compression spring 31 is used to compress the drive plate 28 at all times, so that the compression drive plate 28 is kept perpendicular to the first gear rotation shaft 30. When the combined operation needs to be manually released, the function drive rod 3 is pushed in an axial direction of the first gear rotation shaft 30, the drive plate 28 deflects with an upper end edge 32 of the support frame sheet 29 as a fulcrum, and the function drive rod 7 is disengaged from the linkage clamp slot 23. The lower end of the stroke drive rod 6 is hinged to the gear seat 55. The gear seat 55 is fixed on a second gear rotation shaft 56 in the console 4 (the stroke drive rod 6 may move in the axial direction of the second gear rotation shaft 56 with respect to the gear seat 55). The gear seat 55 is provided with a safety switch with a spring. The stroke drive rod 6 is always in a depressed state when the apparatus operates, so that the stroke drive rod 6 is always in contact with the safety switch (in this embodiment, the apparatus will shut down if the stroke drive rod 6 is released, and the stroke drive rod 6 may also be set to be released according to actual needs to stop the apparatus from moving). The drive plate 28 is sleeved over a guide pin 33 of the support frame sheet 29, and the drive plate 28 is installed on the first gear rotation shaft 30 through a second kidney slot 34. Through the above structure, the function control rod 7 may swing in the lateral direction (the same as the axial direction of the first gear rotation shaft 30) to a certain extent. The swing of the function control rod 7 may be used to make the function control rod disengage from the linkage clamp slot 23 and release the linkage operation with the stroke control rod 6. That is, when the function control rod 7 is in linkage operation state with the stroke control rod 6, the function control rod 7 may be pushed along the axial direction of the first gear rotation shaft 30 to be disengaged from the linkage clamp slot 23. The linkage state is manually released (at this time, the stroke drive rod 6 is still in the depressed state and always in contact with the safety switch), the function control rod 7 resets, and the snow sweeping auger stops rotating.

Referring to FIG. 5 to FIG. 8, the crawler mechanism 9 includes a crawler 35, a transmission gear 36 and a support frame 37. The output shaft 3 is connected to the transmission gear 36 by a bearing seat 38. The transmission gear 36 is matched with a through slot 39 of the crawler 35. The output shaft 3 of the apparatus body 1 drives the transmission gear 36 to rotate. The transmission gear 36 drives the crawler 35 to run by the engagement of the tooth part of the transmission gear with the through slot 39. A plurality of pairs of guide teeth 40 are uniformly installed on the inner side of the crawler 35. A guide cavity 41 corresponding to the transmission gear 36 is formed between each pair of guide teeth 40. The transmission gear 36 may also guide the crawler 35. By applying the crawler mechanism 9 to the snow sweeper, the traveling transmission is carried out by the crawler, and the use range of the snow sweeper is improved. Referring to FIG. 5, the crawler mechanisms 9 are symmetrically installed on both sides of the apparatus body 1, and the two crawler mechanisms 9 are fixedly connected through support connecting rods. Referring to FIG. 5, one end of the crawler mechanism 9 is connected to the output shaft 3, and the other end of the crawler mechanism is movably hinged to the second swing rod 16 of the swing rod group 12.

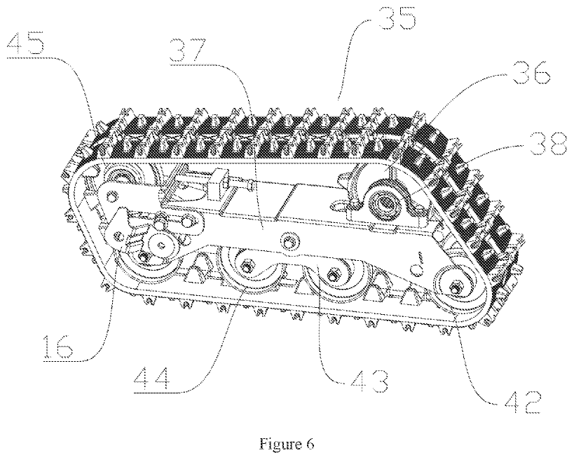

Referring to FIG. 5 to FIG. 6, bearing wheels 42 are installed on both sides of the lower end of the support frame 37. A V-shaped frame 43 and a floating guide wheel 44 installed on the V-shaped frame 43 are movably hinged to the lower end of the support frame 37. The floating guide wheel 44 may play a bearing role. When the crawler 35 travels, the V-shaped frame 43 may swing at any time when encountering obstacles, so that one of the floating guide wheels 44 of the V-shaped frame 43 can still play a bearing role, improving the ground holding effect of the crawler 35. The bearing wheels 42 and the floating guide wheels 44 are arranged outside the guide teeth 40, which can play a role in guiding the crawler 35. The support frame 37 is provided with a tensioning wheel 45 that can adjust the tightness of the crawler 35 The tensioning wheel 45 correspondingly falls into the guide cavity 41, which may also guide the crawler 35.

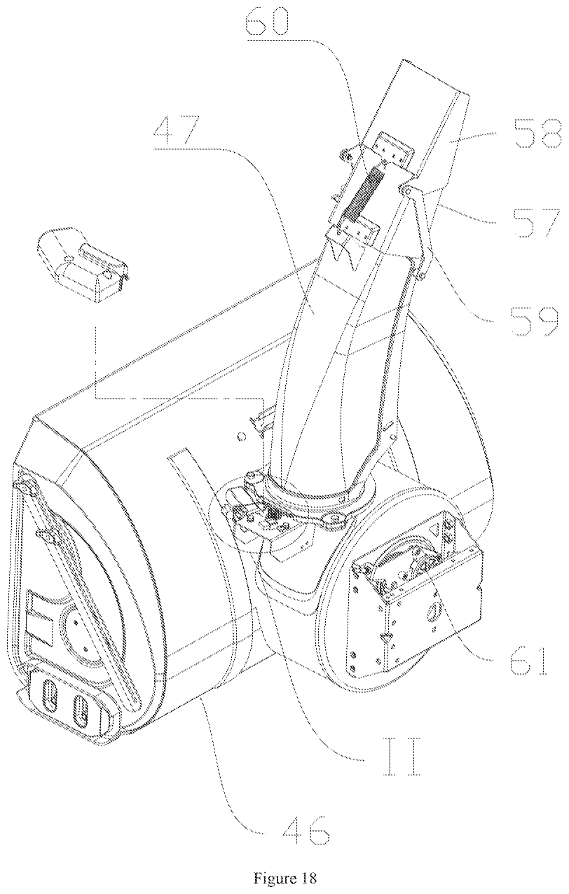

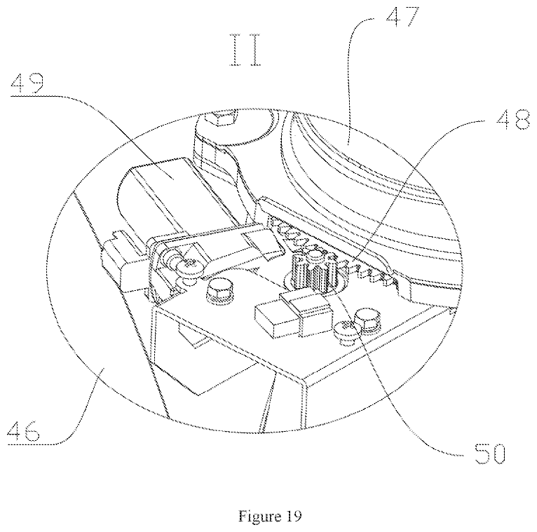

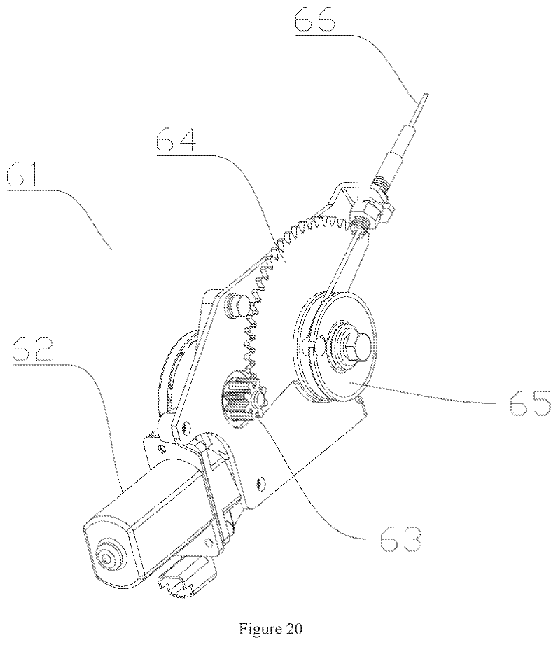

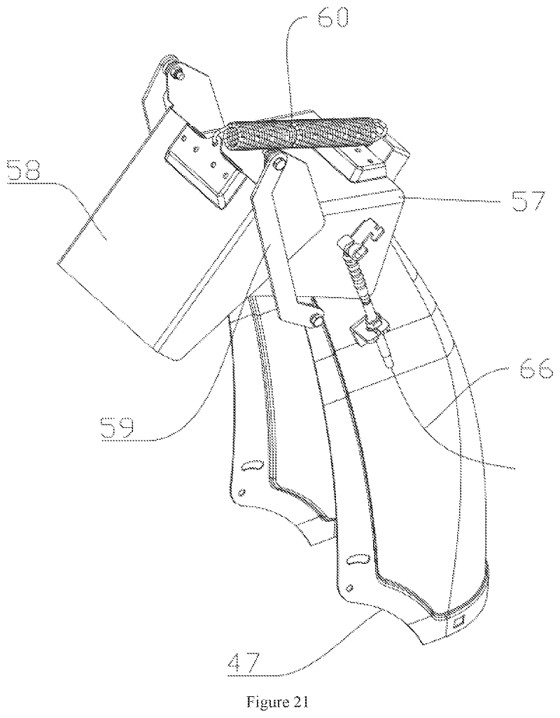

Referring to FIG. 18 to FIG. 19, a snow outlet cover 47 is rotatably installed on a snow sweeping cover shell 46 at the front end of the apparatus body 1. A gear ring 48 is installed at the lower end of the snow outlet cover 47. A steering motor 49 and a steering gear 50 engaged with the gear ring 48 are installed on the snow sweeping cover shell 46. The steering motor 49 drives the steering gear 50 and the gear ring 48 to rotate, thereby driving the entire snow outlet cover 47 to rotate circumferentially. Referring to FIG. 20, a first snow sweeping cap 57 and a second snow sweeping cap 58 are hinged to the upper end of the snow outlet cover 47. A turning connecting rod 59 is hinged between the second snow sweeping cap 58 and the snow outlet cover 47. A snow outlet cap spring 60 is installed between the second snow sweeping cap 58 and the snow outlet cover 47. An angle adjusting mechanism 61 is installed on the snow sweeping cover shell 46. The angle adjusting mechanism 61 includes an adjusting motor 62, an adjusting gear 63 and a sector gear 64 that is engaged with the adjusting gear 63. The sector gear 64 is fixedly provided with a reel 65. The reel 65 is wound with a pulling rope 66 connected to the first snow sweeping cap 57. Snow throwing angles of the two snow sweeping caps are adjusted by pulling the pulling rope 66. FIG. 21 is a perspective view of the two snow sweeping caps of which the snow throwing angles are adjusted to face down.

Referring to FIG. 2 to FIG. 4, the apparatus body 1 is provided with a pedal fixing sheet 51. A locking sheet 52 is hinged to the pedal fixing sheet 51. The pedal fixing sheet 51 is provided with a locking slot 53. A locking pin 54 of the pedal 3 is rotated and clamped into the locking slot 53 by the locking sheet 52. When the pedal 3 is unlocked, the locking sheet 52 only needs to be moved upward to be disengaged from the locking pin 54, and at this time, the pedal 3 is flipped downward due to its own gravity.

This embodiment can be applied to the field of snow sweepers. Through the crawler type traveling transmission, the snow sweeping cover shell and the snow sweeping auger on the apparatus body can be lifted relative to the crawler mechanism, so as to avoid damage caused by external force when the snow sweeping auger does not work. The stroke control rod and the function control rod can be simultaneously controlled through the linkage mechanism, and the function control rod can also be manually toggled to be disengaged from the linkage state. This embodiment can be applied not only to snow sweeper products, but also to apparatuses such as sweepers, snow pushers, weeding machines, etc.

### Embodiment II

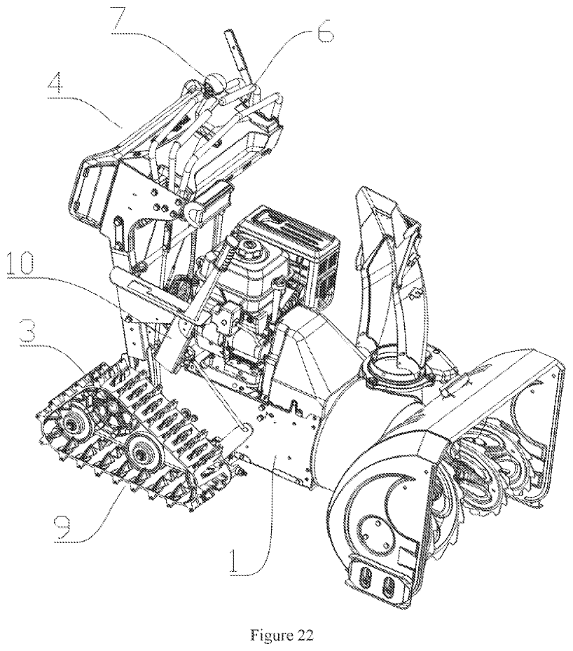

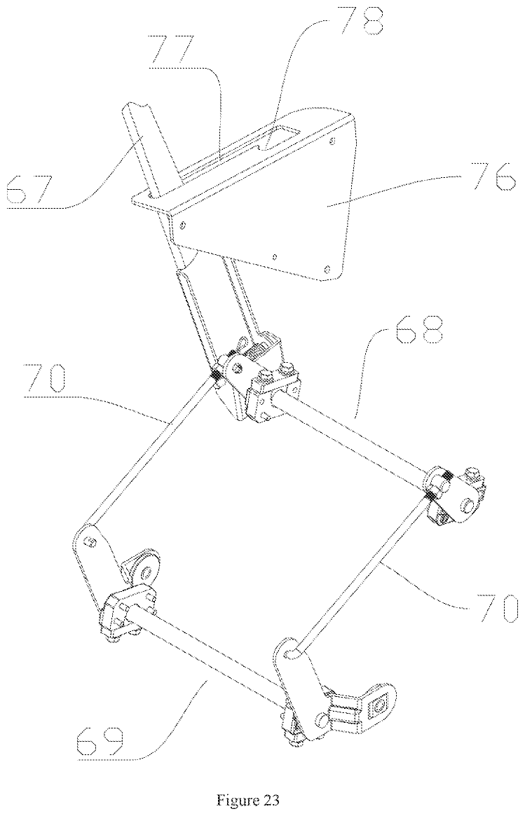

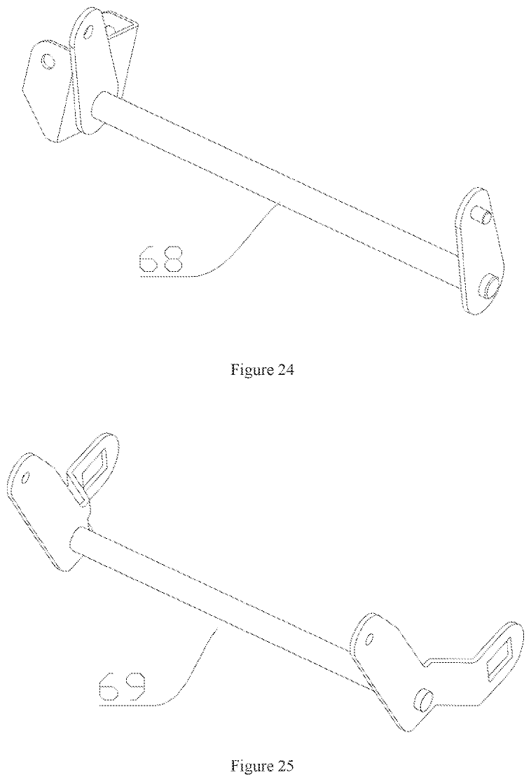

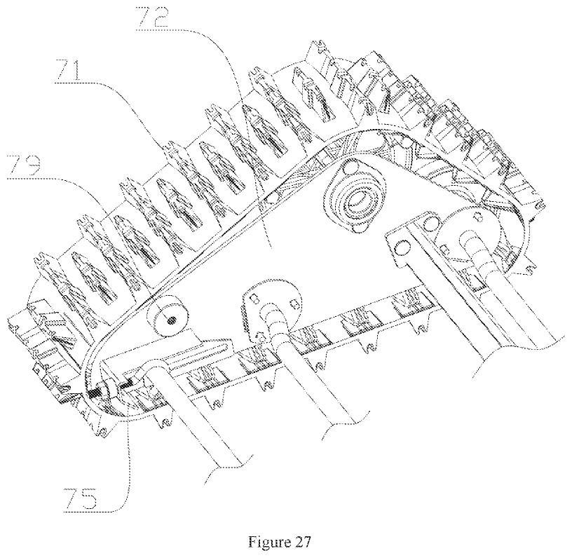

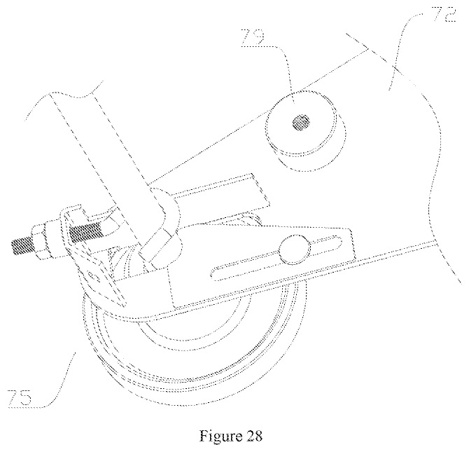

Referring to FIG. 22 to FIG. 28, the difference between this embodiment and Embodiment I is that the height adjusting mechanism is realized by manual operation. This embodiment provides another crawler structure, and the specific structure is as follows:

Referring to FIG. 22 to FIG. 25, the height adjusting mechanism 10 particularly includes a height adjusting handle 67, and an upper rotation rod group 68 and a lower rotation rod group 69 respectively hinged to the apparatus body 1. The height adjusting handle 67 is connected to the upper rotation rod group 68. The lower rotation rod group 69 is movably hinged to the crawler mechanism 9. The upper rotation rod group 68 and the lower rotation rod group 69 are connected by a height-adjustable connecting rod 70. A height adjusting positioning plate 76 is fixed on the apparatus body 1. The height adjusting positioning plate 76 is provided with a gear slot 77 slidably matched with a height adjusting handle 67. The upper end of the gear slot 77 is provided with an upper stroke limit slot 78. When the height adjusting handle 67 is pulled to the upper stroke limit slot 78, the upper rotation rod group 68 and the height-adjustable connecting rod 70 drive the lower rotation rod group 69 to rotate, so as to realize the relative angle rotation of the apparatus body 1 and the crawler mechanism 9, so that the snow sweeping cover shell at the front end of the whole apparatus body 1 is in an elevated state. One end of the upper rotation rod group 68 is rotatably provided with a rotation pin. The upper end of the height-adjustable connecting rod 70 is installed on the rotation pin through a bolt shaft. Therefore, the length of the height-adjustable connecting rod 70 may be adjusted relatively, so as to adjust the initial positions of the upper rotation rod group 68 and the lower rotation rod group 69.

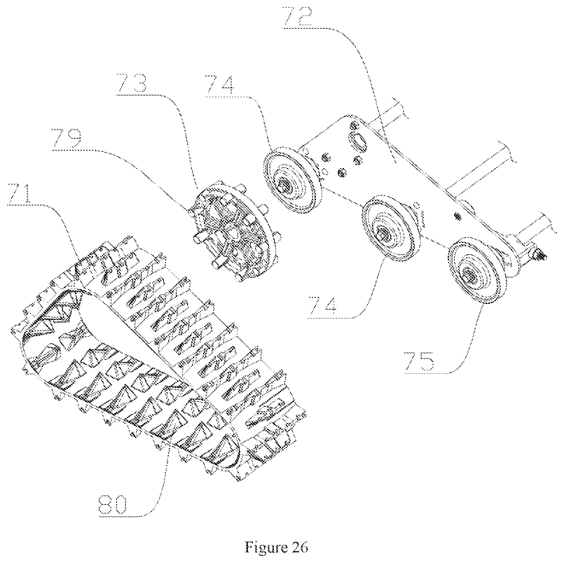

Referring to FIG. 26 to FIG. 28, the crawler mechanism 9 includes a crawler 71, and a triangular support frame 72 and a crawler transmission wheel 73 arranged inside the crawler 71. The crawler transmission wheel 73 is separately connected to the output shaft 3 and the crawler 71. A ring of transmission flange 79 is installed at equal intervals on each of the end faces of both sides of the wheel body of the crawler transmission wheel 73. Multiple pairs of transmission tooth parts 80 corresponding to the transmission flange 79 are installed at equal intervals on the inner wall of the crawler 71. The lower end of the triangular support frame 72 is provided with one or more than one bearing wheel group 74. The lower end of the triangular support frame 72 is provided with a tensioning wheel group 75 which is at a same height as the bearing wheel group 74 and also able to play a bearing role, and it can not only play a role in tensioning and guiding, but also play a role in bearing and supporting. The triangular support frame 72 is provided with a hinged seat 79 for connecting the lower rotation rod group 69.

The above is only the preferred implementations of the disclosure, it should be pointed out that for those of ordinary skill in the art, certain improvements and embellishments can be made without departing from the technical principles of the disclosure, and these improvements and embellishments should also be considered as the protection scope of the disclosure.

1. A standing crawler self-propelled apparatus, comprising:
an apparatus body, wherein a pedal is flippably installed on a rear end of the apparatus body, and output shafts are symmetrically installed on both sides of the apparatus body;
a console, wherein the console is installed on the apparatus body, the console is movably provided with a stroke control rod and a function control rod, and a linkage mechanism is arranged between the stroke control rod and the function control rod; and
a crawler mechanism, wherein one end of the crawler mechanism is connected to the output shafts, and the other end of the crawler mechanism is movably hinged to the apparatus body by a height adjusting mechanism.

2. The standing crawler self-propelled apparatus according to claim 1, wherein the height adjusting mechanism comprises a height adjusting motor and a swing rod group hinged into the apparatus body, a motor base of the height adjusting motor is hinged into the apparatus body, and the height adjusting motor is connected to a push rod by a screw rod mechanism; the swing rod group comprises a first swing rod and a second swing rod mutually fixed; and the first swing rod is hinged to the push rod, and the second swing rod is hinged to the crawler mechanism.

3. The standing crawler self-propelled apparatus according to claim 2, wherein the first swing rod and the second swing rod are welded and fixed by a hinged shaft, a stroke limit switch is installed on the height adjusting motor, and a tension spring is connected between the swing rod group and the apparatus body.

4. The standing crawler self-propelled apparatus according to claim 1, wherein the linkage mechanism comprises a slide rod, a slide rod seat and a linkage block, the slide rod is slidably installed on the slide rod seat, one side of the slide rod is in contact with the stroke control rod, the linkage block is hinged to a hinged support frame in the console, and the linkage block is provided with a linkage clamp slot able to clamp the function control rod; and during combined operation of the stroke control rod and the function control rod, the function control rod is manually pushed into the linkage clamp slot.

5. The standing crawler self-propelled apparatus according to claim 4, wherein the slide rod seat is installed on the hinged support frame , and a reset spring is installed between the linkage block and the hinged support frame; a slide shaft is formed at one end of the slide rod, and the slide shaft is matched with a first kidney slot of the linkage block; and the hinged support frame is provided with a gear slot for accommodating the function control rod, and in a linkage operation state, a “7”-shaped slot is formed between the linkage block and the gear slot.

6. The standing crawler self-propelled apparatus according to claim 4, wherein a lower end of the function control rod is provided with a drive plate, one side of the drive plate is slidably sleeved over a support frame sheet, and the support frame sheet is fixed on a first gear rotation shaft in the console; the drive plate is slidably sleeved over the first gear rotation shaft, and a compression spring is installed between the drive plate and a shaft end of the first gear rotation shaft; when the combined operation needs to be manually released, the function drive rod is pushed in an axial direction of the first gear rotation shaft, the drive plate deflects with an upper end edge of the support frame sheet as a fulcrum, and the function drive rod is disengaged from the linkage clamp slot; and the drive plate is sleeved over a guide pin of the support frame sheet, and the drive plate is installed on the first gear rotation shaft by a second kidney slot.

7. The standing crawler self-propelled apparatus according to claim 1, wherein the crawler mechanism comprises a crawler, a transmission gear and a support frame, the output shaft is connected to the transmission gear by a bearing seat, and the transmission gear is matched with a through slot of the crawler; and a plurality of pairs of guide teeth are uniformly installed on an inner side of the crawler, and a guide cavity corresponding to the transmission gear is formed between each pair of guide teeth.

8. The standing crawler self-propelled apparatus according to claim 7, wherein bearing wheels are installed on both sides of a lower end of the support frame, the lower end of the support frame is movably hinged to a V-shaped frame and a floating guide wheel installed on the V-shaped frame, the bearing wheels and the floating guide wheel are arranged outside the guide teeth, the support frame is provided with a tensioning wheel able to adjust the tightness of the crawler, and the tensioning wheel correspondingly falls into the guide cavity.

9. The standing crawler self-propelled apparatus according to claim 1, wherein a snow outlet cover is rotatably installed on a snow sweeping cover shell at a front end of the apparatus body, a gear ring is installed at a lower end of the snow outlet cover, and a steering motor and a steering gear engaged with the gear ring are installed on the snow sweeping cover shell.

10. The standing crawler self-propelled apparatus according to claim 1, wherein the apparatus body is provided with a pedal fixing sheet, a locking sheet is hinged to the pedal fixing sheet, the pedal fixing sheet is provided with a locking slot, and a locking pin of the pedal is rotated and clamped into the locking slot by the locking sheet.

11. The standing crawler self-propelled apparatus according to claim 1, wherein the height adjusting mechanism comprises a height adjusting handle, and an upper rotation rod group and a lower rotation rod group respectively hinged to the apparatus body, the height adjusting handle is connected to the upper rotation rod group, and the lower rotation rod group is movably hinged to the crawler mechanism; the upper rotation rod group and the lower rotation rod group are connected by a height-adjustable connecting rod; the crawler mechanism comprises a crawler, and a triangular support frame and a crawler transmission wheel arranged inside the crawler, and the crawler transmission wheel is separately connected to the output shaft and the crawler; a lower end of the triangular support frame is provided with one or more than one bearing wheel group, the lower end of the triangular support frame is provided with a tensioning wheel group which is at a same height as the bearing wheel group and also able to play a bearing role.
